(19) United States
(12) Patent Application Publication
(10) Pub. No.: US 2023/0032043 A1
(43) Pub. Date: Feb. 2, 2023

(54) METHODS AND SYSTEMS FOR CONDUCTING ONLINE INSURANCE APPLICATION PROCESS

(71) Applicant: STATE FARM MUTUAL AUTOMOBILE INSURANCE COMPANY, Bloomington, IL (US)

(72) Inventors: Betsy L. Wilkes, Normal, IL (US); Dustin C. Sargent, Bloomington, IL (US); Larry Ingrum, Mahomet, IL (US); Edward W. Breitweiser, Bloomington, IL (US); Ryan J. Merkle, Waynesville, IL (US); Linda McKimmy, Bloomington, IL (US)

(73) Assignee: STATE FARM MUTUAL AUTOMOBILE INSURANCE COMPANY, BLOOMINGTON, IL (US)

(21) Appl. No.: 17/965,354

(22) Filed: Oct. 13, 2022

Related U.S. Application Data
(63) Continuation of application No. 17/103,082, filed on Nov. 24, 2020.
(60) Provisional application No. 62/941,300, filed on Nov. 27, 2019.
(60) Provisional application No. 62/942,336, filed on Dec. 2, 2019.
(60) Provisional application No. 62/972,196, filed on Feb. 10, 2020.
(60) Provisional application No. 63/037,227, filed on Jun. 10, 2020.

(51) Int. Cl. G06Q 40/08; G06Q 10/10

(52) U.S. Cl. CPC G06Q 40/08; G06Q 10/10

(57) ABSTRACT

In one aspect, a computer-implemented method for conducting an online insurance application process may include, via one or more processors, (1) receiving a request from an applicant to start an insurance application; (2) collecting, in response to receiving the request, applicant data from one or more service providers; (3) generating application questions for the applicant based upon the applicant data; (4) prompting the application questions to the applicant; (5) receiving, in response to prompting the application questions, responses to the application questions; and (6) generating a conditional receipt based at least upon the responses of the applicant.

### CROSS-REFERENCE TO RELATED APPLICATIONS

This application claims benefit of U.S. Provisional Patent Application Nos. 62/941,300 (filed Nov. 27, 2019, and entitled “METHODS AND SYSTEMS FOR CONDUCTING ONLINE INSURANCE APPLICATION PROCESS”); 62/942,336 (filed Dec. 2, 2019, and entitled “METHODS AND SYSTEMS FOR CONDUCTING ONLINE INSURANCE APPLICATION PROCESS”); 62/972,196 (filed Feb. 10, 2020, and entitled “METHODS AND SYSTEMS FOR CONDUCTING ONLINE INSURANCE APPLICATION PROCESS”); and 63/037,227 (filed Jun. 10, 2020, and entitled “METHODS AND SYSTEMS FOR CONDUCTING ONLINE INSURANCE APPLICATION PROCESS”), the disclosure of each of which is hereby expressly incorporated by reference herein in its entirety.

Additionally, the present application is related to co-pending U.S. patent application Ser. No. ______ (Atty. Docket No. SF-0002A-NP2, filed Nov. 27, 2020, and entitled “METHODS AND SYSTEMS FOR CONDUCTING ONLINE INSURANCE APPLICATION PROCESS”).

### FIELD OF THE DISCLOSURE

The present disclosure generally relates to insurance application process, and more particularly to methods and systems for conducting an insurance online web-based application process by generating application questions tailored to an applicant to collect relevant information and provide an insurance policy for the applicant.

### BACKGROUND OF THE DISCLOSURE

Traditionally, an applicant seeking to purchase an insurance policy visits a local agent's office to furnish relevant information to the agent, and the agent may collect the applicant's information. In some cases, an insurance provider may require a medical appointment and laboratory testing for applicants seeking life and/or health insurance coverage. However, visiting an agent's office may be time consuming and inconvenient.

Some insurance providers allow applicants to start an insurance application process through a web-based online application process. Typically, during the online application process, the same high-level application questions are given to all applicants. Once the information is collected, the insurance provider decides whether to insure the applicant, and if so, determines an appropriate premium for an issued insurance policy. The decision of whether to issue an insurance policy, as well as the premiums associated with an insurance policy, is generally based upon several risk factors determined from the submitted information. Additionally, because it is online application process, it may be difficult to verify whether the responses provided by the applicant are accurate. As such, it may require an agent of the insurance provider to manually verify the information or conduct an in-person interview and/or a medical exam to verify the information. As a result, the applicant may need to wait for the results before being covered by the policy.

Conventional techniques may be ineffective, inefficient, costly, awkward, and/or include additional drawbacks as well.

### SUMMARY

The present embodiments relate to computer systems and methods that may improve efficiency of the insurance online application process.

In one aspect, a computer-implemented method for conducting an online insurance application process is provided. The method may be implemented via one or more local or remote processors, servers, sensors, and/or transceivers. The method may include (1) receiving a request from an applicant to start an insurance application; (2) prompting the applicant to upload data; (3) receiving, in response to prompting the applicant, first data from the applicant; (4) requesting the applicant for permission to obtain applicant's data from a third-party; (5) obtaining, in response to requesting the applicant, second data; (6) generating application questions for the applicant based upon the first and second data; (7) determining an insurance policy for the applicant based upon the first and second data and compiled responses to the application questions; and/or (8) generating a conditional receipt to the applicant. The method may include sending a link to the applicant's mobile or other computing device to allow the applicant to access and fill out an electronic authorization form specific to a medical facility during the online interview. The method may include additional, less, or alternate actions, including those discussed elsewhere herein.

In another aspect, a computer system for conducting an online insurance application process may be provided. The system may include a network; a computing device; and a server communicatively coupled to the computing device via the network. The server may be configured to: (1) receive a request from an applicant to start an insurance application; (2) prompt the applicant to upload data; (3) receive, in response to a prompt, first data from the applicant; (4) request the applicant for permission to obtain applicant's data from a third-party; (5) obtain, in response to a request, second data; (6) generate application questions for the applicant based upon the first and second data; (7) determine an insurance policy for the applicant based upon the first and second data and compiled responses to the application questions; and/or (8) generate a conditional receipt to the applicant. The computer system and/or server may be configured to send a link to the applicant's mobile or other computing device to allow the applicant to access and fill out an electronic authorization form specific to a medical facility during the online interview. The computer system may be configured with additional, less, or alternate functionality, including that discussed elsewhere herein.

In one aspect, a computer-implemented method for conducting an online insurance application process is provided. The method may be implemented via one or more local or remote processors, servers, sensors, and/or transceivers. The method may include (1) receiving a request from an applicant to start an insurance application; (2) collecting, in response to receiving the request, applicant data from one or more service providers; (3) generating application questions for the applicant based upon the applicant data; (4) prompting the application questions to the applicant; (5) receiving, in response to prompting the application questions, responses to the application questions; and/or (6) generating a conditional receipt based at least upon the responses of the applicant. The method may include additional, less, or alternate actions, including those discussed elsewhere herein.

In another aspect, a computer system for conducting an online insurance application process may be provided. The system may include a network; a computing device; and a server communicatively coupled to the computing device via the network. The server may be configured to: (1) receive a request from an applicant to start an insurance application; (2) collect, in response to a receipt of the request, applicant data from one or more service providers; (3) generate application questions for the applicant based upon the applicant data; (4) prompt the application questions to the applicant; (5) receive, in response to the application questions being prompt to the applicant, responses to the application questions; and/or (6) generate a conditional receipt based at least upon the responses of the applicant. The computer system may be configured with additional, less, or alternate functionality, including that discussed elsewhere herein.

While multiple embodiments are disclosed, still other embodiments of the presently disclosed subject matter will become apparent to those skilled in the art from the following detailed description, which shows and describes illustrative embodiments of the disclosed subject matter. Accordingly, the drawings and detailed description are to be regarded as illustrative in nature and not restrictive.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a block diagram illustrating an exemplary computer system according to an embodiment as disclosed herein;

FIGS. 2-4 are a flow diagram illustrating an exemplary computer-implemented method for generating application questions tailored to an applicant based upon applicant's collected data to determine an insurance policy for the applicant;

FIGS. 5 and 6 are a flow diagram illustrating an exemplary computer-implemented method for determining whether a physical examination is needed for the applicant;

FIG. 7 is a flow diagram illustrating an exemplary computer-implemented method for obtaining a consent form from the applicant prior to a physical examination; and

FIGS. 8 and 9 are a flow diagram illustrating an exemplary computer-implemented method for generating application questions tailored to an applicant based upon applicant's collected data to determine an insurance policy for the applicant.

Corresponding reference characters indicate corresponding parts throughout the several views. Although the drawings represent embodiments of the present disclosure, the drawings are not necessarily to scale, and certain features may be exaggerated in order to better illustrate and explain the present disclosure. The exemplification set out herein illustrates an embodiment of the disclosure, in one form, and such exemplifications are not to be construed as limiting the scope of the disclosure in any manner.

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings. One of ordinary skill in the art will realize that the embodiments provided can be implemented in hardware, software, firmware, and/or a combination thereof. Programming code according to the embodiments can be implemented in any viable programming language or a combination of a high-level programming language and a lower level programming language.

### DETAILED DESCRIPTION

The present embodiments relate to computer systems and methods that may improve efficiency of the insurance online application process. An online life insurance application may include several health-related and financial-related questions for an applicant to answer, including several kick out questions and/or questions about high risk activity. In some embodiments, a chat-bot may be utilized to facilitate gathering customer information, such as gathering requisite permission and authorization to retrieve and access certain information, including medical and prescription records. Other manners of information retrieval may also be utilized, such as text or menu options, or other voice-based options.

With the applicant's permission, consent, or express authorization, the applicant's (i) electronic health records, (ii) prescription history, (iii) medical claim history, and/or (iv) family medical history may be generated and/or retrieved from remote server and/or computers/memory units. The applicant's medical records and history, prescription records and history, medical claim records and history, and/or family medical records and history may be analyzed, such as by one or more machine learning algorithms, programs, modules, or models, to verify their medical information and records, prescription records and history, past medical claims, and family medical history, and/or online application.

In some embodiments, the computer system and/or online application may identify family members, and the computer system may request permission from the family members directly to retrieve and/or access their medical and prescription records. For instance, electronic requests may be transmitted to family members' mobile devices.

Other types of data, including image, audio, and sensor data, may be gathered or collected with the applicant's permission. For instance, the computer system may gather Titbit, vehicle, smart home, wearable, smart glasses, smart watch, and/or mobile device sensor data. The sensor data associated with the applicant may reveal or be related to the applicant's heart activity, heart beat or rate, sleep history, REM or light sleep behavior, swimming, exercise, life style, daily or weekly steps, hiking, etc.

In some aspects, various kick out questions related to high risk activity may be involved with completing the online application. In some embodiments, if there are no high risk activities, temporary or permanent online binding of life insurance may be provided to the applicant upon receipt of payment.

In some embodiments, a medical examination at a medical provider location may be required for permanent binding of the life insurance, or to complete the application. If the medical provider has their own specific or dedicated authorization or consent forms, during the initial online application process and before the applicant logs off, the computer system may retrieve or otherwise generate an electronic authorization or consent form for the applicant to e-sign during the online application process—alleviating the need for the applicant to subsequently fill out any such dedicated authorization or consent form required by the medical provider upon arrival at the medical provider location for a medical exam.

At the end of the online application process, with the applicant's permission, all of the information gathered, generated, or retrieved may be consolidated into an up-to-date electronic medical history for the applicant. The up-to-date electronic medical records may be input into one or more trained machine learning models, modules, algorithms, or programs that are trained to identify or verify medical information and/or generate medical or health recommendations.

Also, if a medical exam is required to complete the application or to provide binding coverage, a type of medical exam may be determined and a medical services provider selected by the computer system. With the applicant's permission, their electronic calendar may be automatically accessed to schedule the medical exam with the medical services provider during an available time slot on the applicant's calendar.

Exemplary Computer System

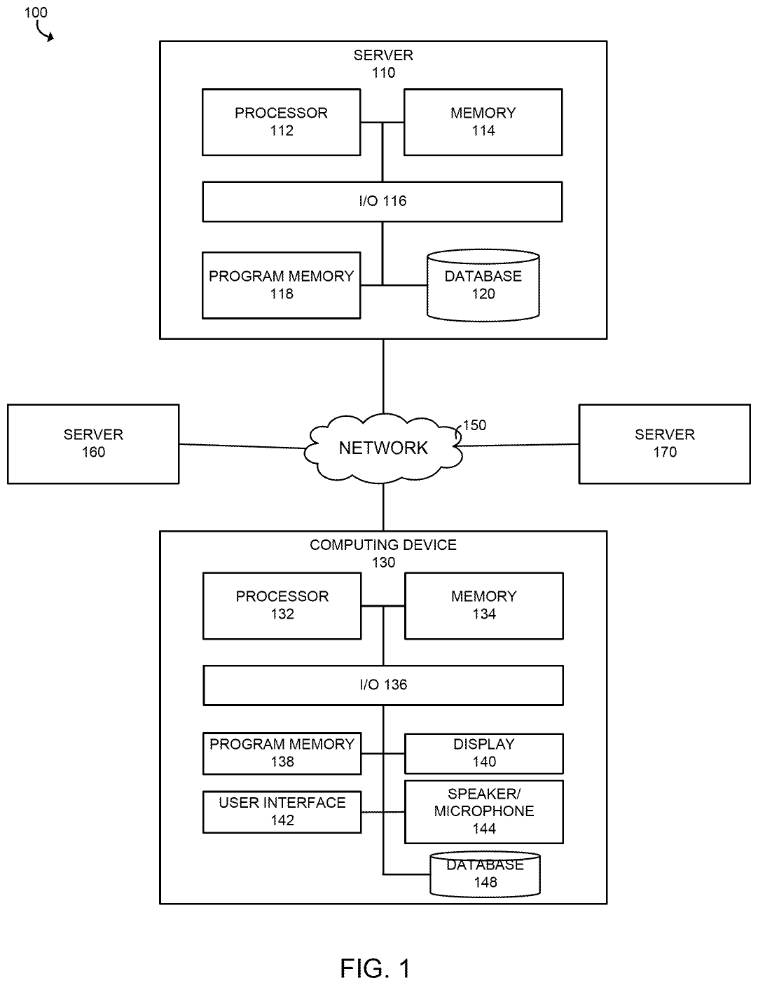

FIG. 1 is a block diagram of a computer system 100 for generating application questions tailored to an applicant based upon data collected from the applicant and/or third-parties to provide an insurance policy for the applicant. The system 100 may include a server 110 (e.g., an insurance provider's computer system) and a computing device 130 associated with an applicant that is communicatively coupled to the server 110 via a network 150 (e.g., a local area network (LAN), a wide area network (WAN), a personal area network (PAN), the Internet, etc.). The system 100 may further include one or more servers 160, 170 that are associated with third-party network/systems (e.g., a hospital network system, a wearable device cloud system, third-party insurance network).

In general, the computing device 130 may include any existing or future devices capable of detecting, collecting, storing, transmitting, and/or displaying data associated with the applicant. For example, the computing device may be, but is not limited to, a computer, a notebook, a laptop, a mobile device, a smartphone, a tablet, wearable, smart glasses, or any other suitable computing device that is capable of communicating with the server 110. In operation, the computing device 130 is operated by an applicant to start an insurance application process for an insurance coverage. For example, the applicant may use an application (e.g., an insurance application) running on the applicant's mobile device (e.g., the computing device 130) to start the application process. For example, the data discussed herein may be collected or received by the applicant's mobile device (e.g., 130), an application running thereon, and/or an insurance provider remote server, such as via direct or indirect wireless communication or data transmission from the application running on the applicant's mobile device.

The applicant may transfer data to the computing device 130 to be transmitted to the server 110. Additionally or alternatively, the data may be already stored on the computing device 130. The data may include previous medical claim(s), previous pharmacy claim(s), medical record(s) (including family history), criminal record(s), motor vehicle record(s), and data from a wearable device(s) related to the applicant. For example, the computing device 130 may be in communication with a wearable device (not shown) (e.g., a smart watch, a fitness bracelet, or smart glasses) that is configured to measure fitness activities such as walking, running, biking, weight training, etc. and/or biometric markers such as blood glucose levels, cholesterol levels, vitamin levels, etc. Such a wearable device may include temperature sensors, motion sensors, heart rate monitors, pulse oximeters, sleep pattern monitors, smart scales, smart utensils, and the like.

The computing device 130 includes a processor 132 (e.g., a central processing unit (CPU), a graphics processing unit (GPU)), a memory 134 (e.g., random-access memory (RAM), read-only memory (ROM), flash memory), an input/output (I/O) controller 136 (e.g., a network transceiver), a memory unit 138, a display 140, a user interface 142 (e.g., a display screen, a touchscreen, a keyboard), and a speaker/microphone 144, all of which may be interconnected via one or more address/data bus. It should be appreciated that although only one processor 132 is shown, the computing device 130 may include multiple processors 132. Although the I/O controller 136 is shown as a single block, it should be appreciated that the I/O controller 136 may include a number of different types of I/O components.

The computing device 130 may further include a database 148. As used herein, the term “database” may refer to a single database or other structured data storage, or to a collection of two or more different databases or structured data storage components. In the illustrative embodiment, the database 148 is part of the computing device 130. In some embodiments, the computing device 130 may access the database 148 via a network such as network 150. The database 148 may store applicant's data that is to be transmitted to the server 110. For example, the data may include previous medical claim(s), previous pharmacy claim(s), medical record(s), criminal record(s), motor vehicle record(s), and data from a wearable device(s).

The computing device 130 may further include a number of software applications stored in memory unit 138, which may be called a program memory. The various software applications on the computing device 130 may include specific programs, routines, or scripts for performing processing functions associated with the methods described herein. Additionally or alternatively, the various software applications on the computing device 130 may include general-purpose software applications for data processing, database management, data analysis, network communication, web server operation, or other functions described herein or typically performed by a server. The various software applications may be executed on the same computer processor or on different computer processors. Additionally, or alternatively, the software applications may interact with various hardware modules that may be installed within or connected to the computing device 130. Such modules may implement part of or all of the various exemplary method functions discussed herein or other related embodiments.

Although only one computing device 130 is shown in FIG. 1, the server 110 is capable of communicating with multiple computing devices similar to the computing device 130, wherein each computing device is associated with an applicant and is configured to transmit the information to the server 110.

Referring now to the server 110, the server 110 includes a processor 112 (e.g., a microprocessor, a microcontroller), a memory 114, and an input/output (I/O) controller 116 (e.g., a network transceiver). The server 110 may be a single server or a plurality of servers with distributed processing. In operation, the server 110 receives data related to the applicant from the computing device 130 and/or other servers 160, 170 and may store the data in the database 120. The server 110 then analyzes the data to generate application questions tailored to the applicant to provide an insurance policy. It should be appreciated that the server 110 may have artificial intelligence capabilities that perform machine learning in generating application questions based upon historical data obtained by collecting and analyzing past system performances. By providing the application questions more tailored to the applicant, the server 110 may obtain more relevant data specific to the applicant (e.g., based upon family history). Additionally, the personalized application questions may even help the applicant to remember certain relevant information (e.g., by using leading questions) that the applicant may have otherwise forgotten.

Based upon data collected from the applicant and/or third-party servers, the server 110 may be configured to determine whether a physical exam (also commonly referred to as a medical exam) is needed for an applicant. For example, if an applicant is a healthy and young individual who is seeking a low amount of insurance coverage, a physical exam may not be necessary. To do so, the server 110 may determine whether the applicant is taking a prescription drug based on collected data (i.e., data received from the computing device 130 and/or data obtained from third-party servers). Additionally or alternatively, the server 110 may determine whether the applicant is taking a prescription drug by prompting the applicant for a response. For example, the server 110 may prompt the applicant whether the applicant is taking a prescription drug even though the collected data indicates that the applicant is taking a prescription drug to verify the information.

If the server 110 determines that the applicant is taking a prescription drug, the server 110 may prompt the applicant whether the prescription drug is not directly related to a health condition. For example, an applicant may be taking a prescription drug for high blood pressure. However, the applicant may indicate that the applicant does not have high blood pressure and the reason for taking the prescription drug for high blood pressure is because of another prescription drug that he is taking.

If the applicant indicates that the reason for taking the prescription medication is not related to a health condition, the server 110 may verify accuracy of the response received from the applicant based upon the collected data. For example, the server 110 may determine whether the response is reasonable based upon at least one of applicant's previous medical claim(s), previous pharmacy claim(s), medical record(s), criminal record(s), motor vehicle record(s), and data from a wearable device(s) (e.g., exercise data, blood pressure, heart rate, pulse, oxygen level, sleep pattern, weight, and temperature). If the response is not verified, the server 110 may provide a reason for unverified information to the applicant and may ask the applicant to submit supplemental documents to verify the reason why the applicant is taking the prescription drug not directly related to his health condition.

Additionally, the server 110 may be configured to determine whether a physical exam is needed based upon the collected data. To do so, for example, the server 110 may determine whether a physical exam is needed based upon the health record(s) including whether the applicant is taking a prescription drug(s) that is related to his health condition. Additionally or alternatively, the server 110 may determine whether a physical exam is needed based upon the applicant's age, health record(s), criminal record(s), motor vehicle record(s), and data from a wearable device(s) (e.g., exercise, blood pressure, heart rate, pulse, oxygen level, sleep pattern, weight, and temperature).

If the server 110 determines that a physical exam is needed, the server 110 may prompt the applicant with available physical exam time slots at a health service provider(s) based upon the applicant's calendar. The health service provider may be determined based upon the applicant's home or work address. Additionally, the server 110 may determine the applicant's location when applicant is available based upon the applicant's calendar and determine the health service provider(s) based upon the applicant's location. The server 110 may make an appointment with a health service provider based upon the applicant's feedback. Alternatively, in some embodiments, the server 110 may prompt the applicant with available physical exam time slot(s) for a nurse to visit applicant's home to conduct a physical exam.

Additionally or alternatively, the server 110 may send an email and/or a text message to the applicant with a link so that the applicant can make an appointment for a physical exam online. Also, if the medical facility has any special authorization forms, such as an authorization form specific to that the medical facility, the server 110 may send an email and/or text message to the application with a link so that the applicant can fill out that special authorization form during the online interview. For instance, if the medical facility has its own authorization or other forms that are required to signed by the applicant prior to the medical facility performing any services, the server 110 may send an email and/or text message to the application with a link so that the applicant can fill out any of those forms during the online interview—such as to avoid the filling out those forms at a later date, such as when the applicant arrives at the medical facility for an appointment.

The processor 112 as disclosed herein may be any electronic device that is capable of processing data, for example a central processing unit (CPU), a graphics processing unit (GPU), a system on a chip (SoC), or any other suitable type of processor. It should be appreciated that the various operations of example methods described herein (i.e., performed by the server 110) may be performed by one or more processors 112. The memory 114 may be a random-access memory (RAM), read-only memory (ROM), a flash memory, or any other suitable type of memory that enables storage of data such as instruction codes that the processor 112 needs to access in order to implement any method as disclosed herein.

A database 120, which may be a single database or a collection of two or more databases, is coupled to the server 110. In the illustrative embodiment, the database 120 is part of the server 110. In some embodiments, the server 110 may access the database 120 via a network such as the network 150. The server 110 may also include various software applications stored in the memory 118 and executable by the processor 112. These software applications may include specific programs, routines, or scripts for performing functions associated with the methods described herein. Additionally, the software applications may include general-purpose software applications for data processing, database management, data analysis, network communication, web server operation, or other functions described herein or typically performed by a server.

The network 150 is any suitable type of computer network that functionally couples at least one computing device 130 with the server 110. The network 150 may include a proprietary network, a secure public internet, a virtual private network and/or one or more other types of networks, such as dedicated access lines, plain ordinary telephone lines, satellite links, cellular data networks, or combinations thereof. In embodiments where the network 150 comprises the Internet, data communications may take place over the network 150 via an Internet communication protocol.

Exemplary Computer-Implemented Method

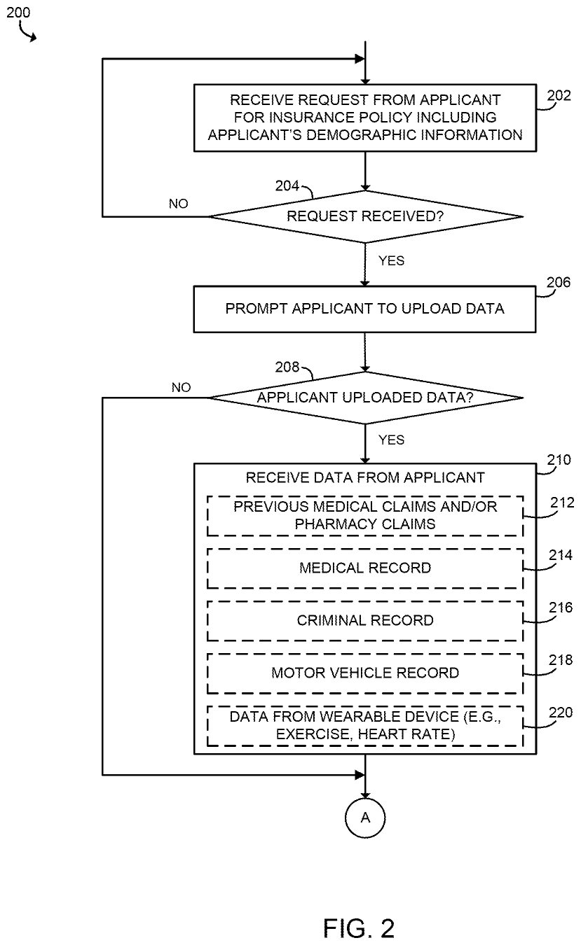

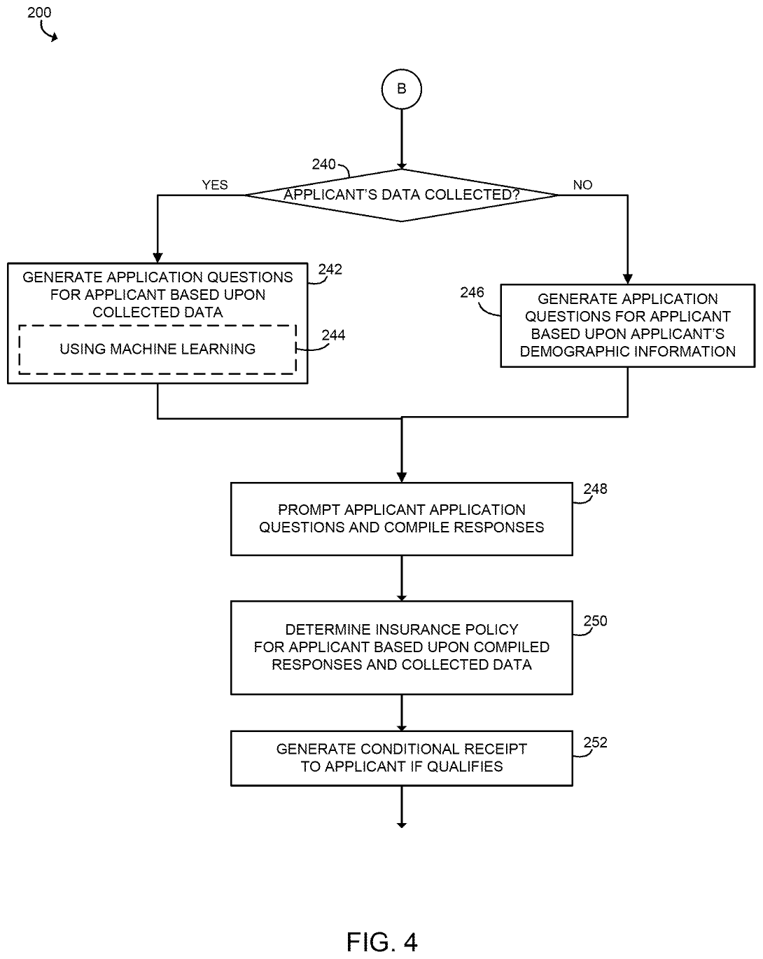

Referring now to FIGS. 2-4, a computer-implemented method 200 for providing application questions tailored to an applicant requesting an insurance policy (e.g., life or health insurance) is shown. In the illustrative embodiment, the method 200 is performed by a server (e.g., 110). To do so, in block 202, the server 110 receives a request from an applicant for an insurance policy from a computing device (e.g., 130). As discussed above, the computing device may be a computer, a notebook, a laptop, a mobile device, a smartphone, a tablet, or any other suitable computing device that is used by the applicant to request the insurance policy.

The request includes applicant's demographic information. For example, the demographic information may include, but not limited to, age, race, ethnicity, gender, marital status, income, education, and/or employment. In some embodiments, the request may further include family history of the applicant. If the request is not received in block 204, the method 200 loops back to block 202 to continue waiting for a request from an applicant. If, however, the request is received in block 204, the method 200 advances to block 206.

In block 206, the server 110 prompts the applicant to upload data from the computing device. The data that may be uploaded by the applicant may include previous medical claim(s), previous pharmacy claim(s), medical record(s), criminal record(s), motor vehicle record(s), and data from a wearable device(s). In some embodiments, the server 110 may allow the applicant to upload data from another computing device different from the computing device that is being used to start the application process.

If the server 110 determines that the applicant has uploaded data in block 208, the method 200 advances to block 210 to receive data from the applicant. In some embodiments, the server 110 may receive previous medical claim(s) and/or previous pharmacy claim(s) as indicated in block 212. Additionally or alternatively, in some embodiments, the server 110 may receive the medical record(s) 214, the criminal record(s) 216, and/or the motor vehicle record(s) 218 as indicated in blocks 214, 216, and 218, respectively.

Additionally or alternatively, in some embodiments, the server 110 may receive data from a wearable device(s) as indicated in block 220. For example, the data from a wearable device may include, but not limited to, exercise data, blood pressure, heart rate, pulse, oxygen level, sleep pattern, weight, and temperature. Subsequent to receiving the uploaded data from the applicant, the method 200 proceeds to block 222. Referring back to block 208, if the server 110 determines that the applicant has not uploaded data, the method 200 skips ahead to block 222.

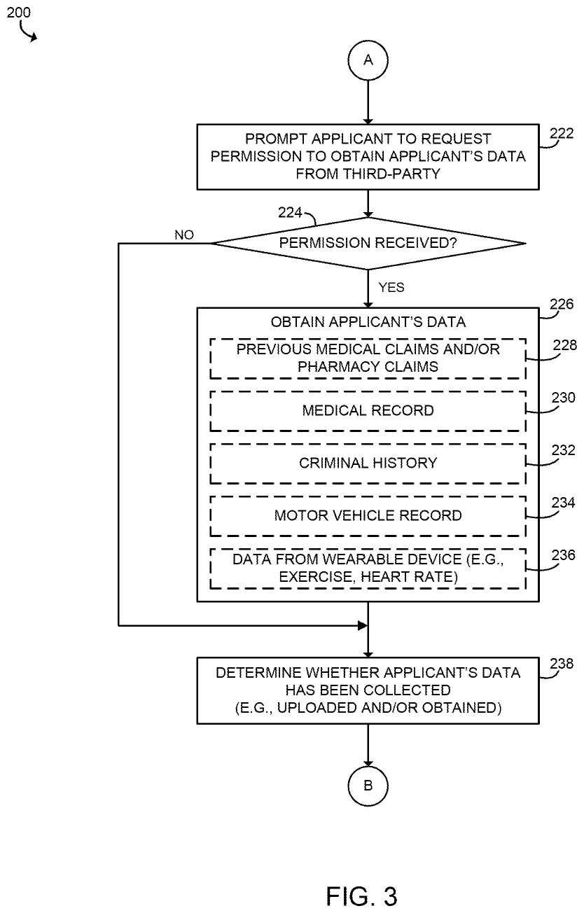

In block 222 shown in FIG. 3, the server 110 prompts the applicant to request permission to obtain applicant's data from one or more third-party servers. If the permission is granted in block 224, the method 200 advances to block 226 to obtain data. If, however, the permission is not granted, the method 200 skips ahead to block 238.

In block 226, the server 110 communicates with one or more third-party servers to obtain applicant's data. For example, obtained data may include previous medical claim(s) and/or pharmacy claim(s), medical record(s), criminal record(s), motor vehicle record(s), and data from a wearable device(s), as indicated in blocks 228-236, respectively.

In block 238, the server 110 determines whether applicant's data has been collected. For example, the collected data may be uploaded by the applicant and/or obtained by the server 110 with the permission of the applicant.

Subsequently, if the server 110 determines in block 240 that the applicant's data has been collected, the method 200 advances to block 242 to generate application questions for the applicant based upon the collected data. It should be appreciated that, in some embodiments, the server 110 may perform machine learning to generate application questions based upon historical data obtained by collecting and analyzing past system performances, as indicated in block 244. As discussed above, by providing the application questions more tailored to the applicant, the server 110 can obtain more relevant data specific to the applicant. Additionally, the personalized application questions may even help the applicant to remember certain relevant information (e.g., by using leading questions) that the applicant may have otherwise forgotten.

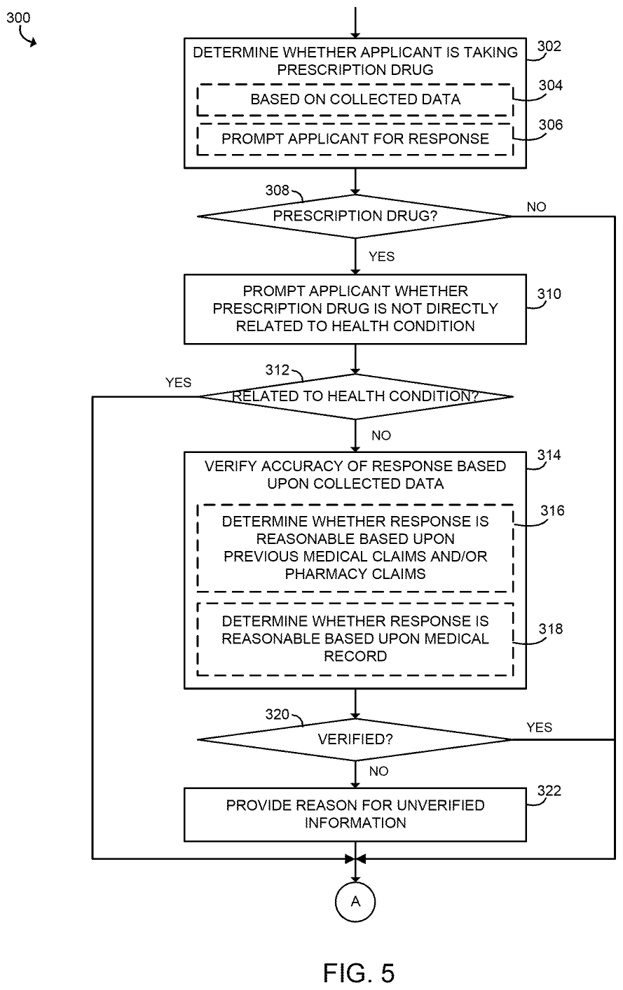

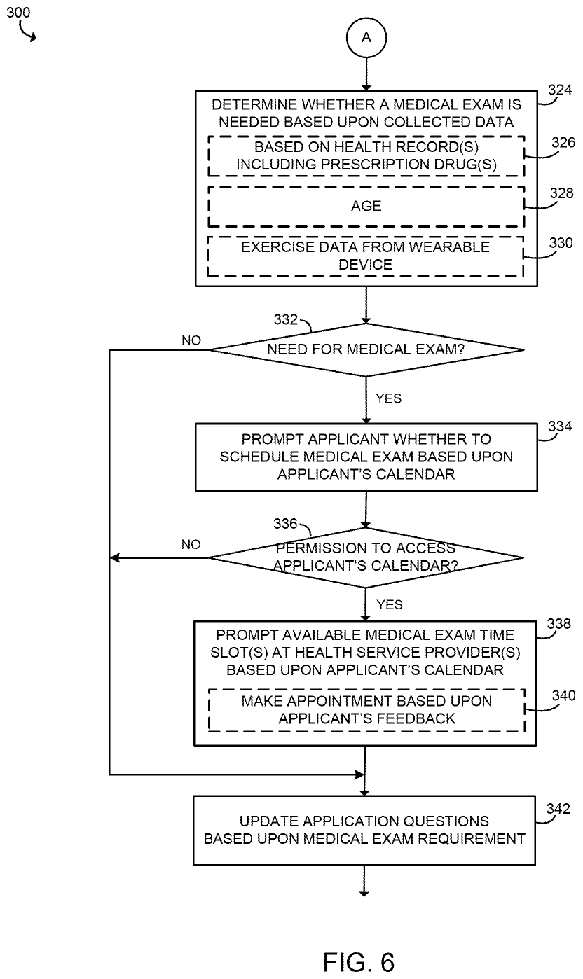

If, however, the server 110 determines that the applicant's data has not been collected in block 240, the method 200 skips ahead to block 246 to generate application questions based upon applicant's demographic information. Subsequently, in block 248, the server 110 prompts the applicant application questions and compiles responses. Example application questions are illustrated in FIGS. 5 and 6, which is discussed in detail below.

In block 250, the server 110 determines an insurance policy for the applicant based upon the compiled response and the collected data. For example, an applicant may be disqualified from a temporary coverage benefit if the compiled response and the collected data indicate that the applicant has been diagnosed with human immunodeficiency virus (HIV) or the Acquired Immune Deficiency Syndrome (AIDS), the applicant is presently incarcerated, and/or the applicant has had a myocardial infarction within three years of the date of application of a life insurance policy.

Subsequently, in block 252, the server 110 generates a conditional receipt to the applicant if the applicant qualifies for temporary coverage benefits. The conditional receipt is temporary coverage or a “binding receipt” for an insurance policy. The conditional receipt may provide immediate temporary insurance coverage for the applicant until a policy is subsequently issued or unissued by the insurance provider.

It should be understood that although the method 200 is described as being performed by the server 110, in some examples, such method may be performed by one or more processors of the server 110.

Exemplary Computer-Implemented Method

Referring now to FIGS. 5 and 6, a computer-implemented method 300 for determining whether a physical examination is needed for an applicant is shown. As discussed above, it may be time consuming and burdensome for an applicant to get a physical examination. In some cases, a physical exam may not be necessary. For example, if an applicant is a healthy and young individual who is seeking for a low amount of insurance coverage, a physical exam may not be necessary.

In the illustrative embodiment, the method 300 is performed by a server (e.g., 110) and may be part of block 248 of the method 200. In other words, the method 300 may be one of the application questions that is generated and is being prompted to an applicant during the insurance application process to determine whether a physical exam is needed. To do so, in block 302, the server 110 determines whether an applicant is taking a prescription drug. To do so, the server 110 may determine whether the applicant is taking a prescription drug based on collected data (i.e., data received from the applicant and/or data obtained from third-party servers), as indicated in block 304.

Additionally or alternatively, the server 110 may determine whether the applicant is taking a prescription drug by prompting the applicant for a response, as indicated in block 306. For example, the server 110 may prompt the applicant whether the applicant is taking a prescription drug even though the collected data indicates that the application is taking a prescription drug in order to verify the information. If the server 110 determines that the applicant is taking a prescription drug based upon the collected data but the applicant responded that the applicant is not taking a prescription drug, the server 110 may generate and prompt another question to the applicant to verify that the applicant is no longer taking the prescription drug. In some embodiments, the server 110 may ask the applicant to submit a supporting document.

If the server 110 determines that the applicant is not taking a prescription drug in block 308, the method 300 skips ahead to block 324 in FIG. 6, which is discussed in detail below.

If, however, the server 110 determines that the applicant is taking a prescription drug in block 308, the method 300 advances to block 310 to prompt the applicant whether the prescription drug is not directly related to a health condition. For example, an applicant may be taking a prescription drug for high blood pressure. However, the applicant may indicate that the applicant does not have high blood pressure but the reason for taking the prescription drug for high blood pressure is because of another prescription drug that he is taking.

If the server 110 determines that the applicant indicated that the reason for taking the prescription medication is related to a health condition in block 312, the method 300 skips ahead to block 324 in FIG. 6. If, however, the server 110 determines that the applicant indicated that the reason for taking the prescription medication is not related to a health condition in block 312, the method 300 advances to block 314.

In block 314, the server 110 verifies accuracy of the response received from the applicant based upon the collected data. As discussed above in the method 200, the collected data may include previous medical claim(s), previous pharmacy claim(s), medical record(s), criminal record(s), motor vehicle record(s), and data from a wearable device(s) (e.g., exercise data, blood pressure, heart rate, pulse, oxygen level, sleep pattern, weight, and temperature). For example, the server 110 may determine whether the response is reasonable based upon the previous medical claims and/or pharmacy claims, as indicated in block 316. Additionally or alternatively, the server 110 may determine whether the response is reasonable based upon the medical record(s), as indicated in block 318. Although it is not shown in FIG. 5, in some embodiments, the server 110 may determine whether the response is reasonable based upon any of the collected data, including criminal record(s), motor vehicle record(s), and data from a wearable device(s) (e.g., exercise data, blood pressure, heart rate, pulse, oxygen level, sleep pattern, weight, and temperature).

If the response is not verified in block 320, the method 300 advances to block 322 to provide a reason for unverified information to the applicant. In some embodiments, the server 110 may ask the applicant to submit supplemental documents to verify the reason why the applicant is taking the prescription drug not directly related to his health condition. Subsequently, the method 300 advances to block 324 in FIG. 6. If, however, the response is verified in block 320, the method 300 skips to block 324.

In block 324 shown in FIG. 6, the server 110 determines whether a physical exam is needed based upon the collected data. To do so, for example, the server 110 may determine whether a physical exam is needed based upon the health record(s) including whether the applicant is taking a prescription drug(s) that is related to his health condition, as indicated in block 326. Additionally or alternatively, the server 110 may determine whether a physical exam is needed based upon the applicant's age and/or exercise data from a wearable device, as indicated in blocks 328 and 330, respectively. Although it is not shown in FIG. 5, in some embodiments, the server 110 may determine whether a physical exam is needed based upon any of the collected data, including criminal record(s), motor vehicle record(s), and other data from a wearable device(s) (e.g., blood pressure, heart rate, pulse, oxygen level, sleep pattern, weight, and temperature).

If the server 110 determines that a physical exam is not needed in block 332, the method 300 skips ahead to block 342 to update the application questions based upon the physical exam requirement.

If, however, the server 110 determines that a physical exam is needed in block 332, the method 300 advances to block 334. In block 334, the server 110 prompts the applicant whether to schedule a physical exam based upon the applicant's calendar. If the server 110 does not receive a permission to access the applicant's calendar in block 336, the method 300 skips ahead to block 342 to update the application questions based upon the physical exam requirement.

In some embodiments, the server 110 may send an email and/or a text message to the applicant with a link so that the applicant can make an appointment for a physical exam online. If the medical facility has any special authorization forms, such as an authorization form specific to that the medical facility, the server 110 may send an email and/or text message to the application with a link so that the applicant can fill out that special authorization form during the online interview. For instance, if the medical facility has its own authorization or other forms that are required to signed by the applicant prior to the medical facility performing any services, the server 110 may send an email and/or text message to the application with a link so that the applicant can fill out any of those forms during the online interview—such as to avoid the filling out those forms at a later date, such as when the applicant arrives at the medical facility for an appointment.

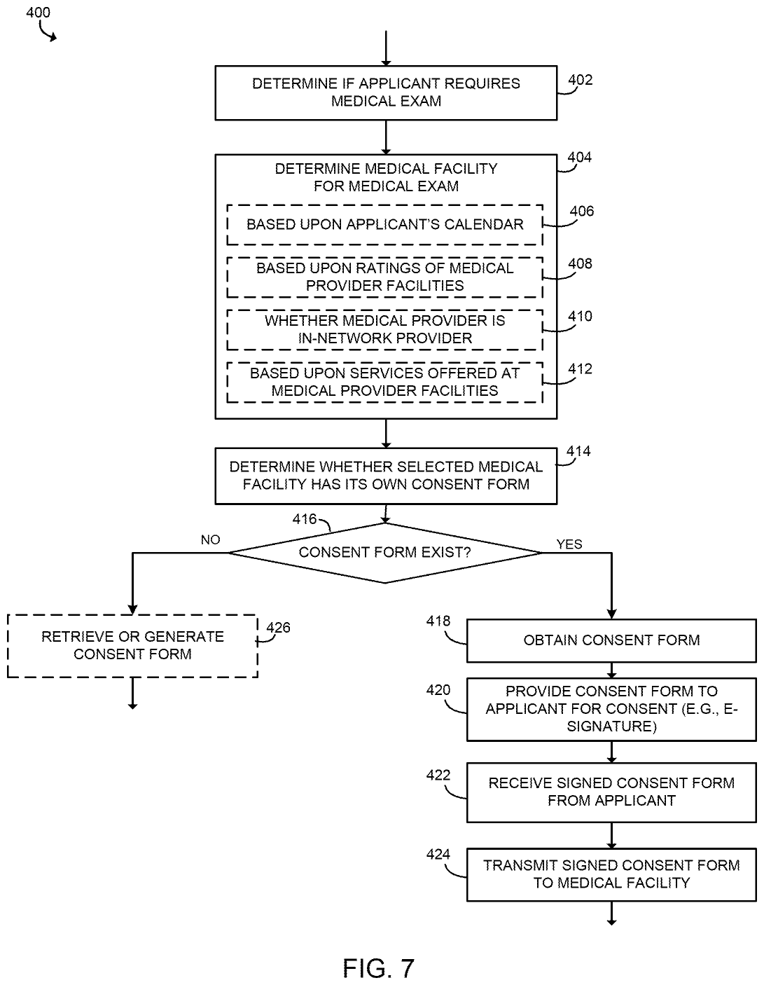

As discussed further in FIG. 7, the server 110 may retrieve or generate the dedicated electronic consent form specific to a medical facility for the physical examination (also commonly referred to as medical examination) or other medical services provider; and/or send or transmit the dedicated electronic authorization or consent form specific to a medical facility for the medical exam or other medical services provider to the applicant's mobile device or other computing device to allow completion by the applicant prior to the medical exam and during the initial online application process or session. Additionally or alternatively, the server 110 may identify or generate an electronic link to the dedicated electronic authorization or consent form specific to a medical facility for the medical exam or other medical services provider; and/or send or transmit the electronic link to the dedicated electronic authorization or consent form specific to a medical facility for the physical examination or other medical services provider to the applicant's mobile device or other computing device to allow completion of the authorization or consent form by the applicant prior to the physical examination and during the initial online application process or session.

Returning back to the FIG. 6, if, however, the server 110 receives a permission to access the applicant's calendar in block 336, the method 300 advances to block 338. In block 338, the server 110 prompts the applicant with available physical exam time slots at a health service provider(s) based upon the applicant's calendar. The health service provider may be determined based upon the applicant's home or work address. Additionally, the server 110 may determine the applicant's location when applicant is available based upon the applicant's calendar and determine the health service provider(s) based upon the applicant's location. The server 110 may make an appointment with a health service provider based upon the applicant's feedback, as indicated in block 340. Additionally or alternatively, in some embodiments, the server 110 may prompt the applicant with available physical exam time slot(s) for a nurse to visit applicant's home to conduct a physical exam.

Additionally or alternatively, it should be appreciated that, in some embodiments, the server 110 may send an email and/or a text message to the applicant with a link so that the applicant can make an appointment for a physical exam online. At that point, if the medical facility has any special authorization forms, such as an authorization form specific to that the medical facility, the server 110 may send an email and/or text message to the application with a link so that the applicant can fill out that special authorization form during the online interview.

In some embodiments, the method may include, via one or more local or remote processors, servers, sensors, and/or transceivers, when a medical exam is required to complete the application or providing binding life insurance or other coverage, determining, during the online interview or application process, that a dedicated electronic authorization or consent form specific to a medical facility for the medical exam or other medical services provider is required to be completed by applicant prior to the medical exam.

The method may include, via one or more local or remote processors, servers, sensors, and/or transceivers, retrieving the dedicated electronic authorization or consent form specific to a medical facility for the medical exam or other medical services provider; and/or sending or transmitting, the dedicated electronic authorization or consent form specific to a medical facility for the medical exam or other medical services provider to the applicant's mobile device or other computing device to allow completion by the applicant prior to the medical exam and during the initial online application process or session. Additionally or alternatively, the method may include, via one or more local or remote processors, servers, sensors, and/or transceivers, identifying, an electronic link to the dedicated electronic authorization or consent form specific to a medical facility for the medical exam or other medical services provider; and/or sending or transmitting the electronic link to the dedicated electronic authorization or consent form specific to a medical facility for the medical exam or other medical services provider to the applicant's mobile device or other computing device to allow completion of the authorization or consent form by the applicant prior to the medical exam and during the initial online application process or session.

Subsequently, the method 300 proceeds to block 342 to update the application questions based upon the physical exam requirement and/or the physical exam appointment.

Exemplary Computer-Implemented Method

Referring now to FIG. 7, a computer-implemented method 400 for obtaining a consent form from an application prior to a physical exam is shown. In the illustrative embodiment, the method 400 is performed by a server (e.g., 110). As discussed above, a physical examination at a medical facility may be required for permanent binding of the life insurance, or to complete the application, and it may be time consuming and burdensome for an applicant. By allowing the applicant to complete an electronic consent form in advance, it alleviates the need for the applicant to subsequently fill out any such dedicated authorization or consent form required by the medical facility upon arrival at the medical facility for a physical examination and, thus, may minimize the time spent at the physical examination appointment.

To do so, the server 110 determines whether an applicant needs a physical examination in block 402. As described above, the applicant may need a physical examination based on data obtained or received during the application process. If the server 110 determines that the physical examination is required in block 402, the method 400 advances to block 404 to determine a medical facility that is available to the applicant for the physical examination.

In some embodiments, the server 110 may select a medical facility based upon the Applicant's calendar, as indicated in block 406. To do so, the server 110 may access the Applicant's calendar, upon Applicant's authorization, to determine available dates and time slots and Applicant's whereabouts during those available time slots based upon Applicant's appointments before and after the available time slots. The server 110 may then determine a medical facility that is geographically close to where the Applicant is likely to be and determine whether the medical facility has an available appointment at that time slot.

Additionally or alternatively, in some embodiments, the server 110 may select a medical facility based upon ratings of the medical provider facilities, whether the medical provider associated with the medical facility is in-network, and/or based upon services that are offered at medical provider facilities, as indicated in blocks 408-412. It should be appreciated that additional information that is needed (e.g., ratings of the medical provider facilities, in-network or out-of-network provider information, and/or provided services at medical provider facilities) may be obtained or received from another server (e.g., 160, 170).

Once the medical facility is determined and selected, the server 110 determines whether the selected medical facility has its own consent form specific to the medical facility for the physical examination, as indicated in block 414. If the server 110 determines that the selected medical provider does not have its own specific or dedicated consent form in block 416, the method 400 skips ahead to block 426. In some embodiments, in response to determining that the selected medical provider does not have its own consent form, the server 110 may retrieve a generic electronic consent form stored in its database (e.g., 120) or generate an electronic consent form for the applicant for the selected medical facility, as indicated in block 426.

Referring back to block 416, if the server 110 determines that the selected medical facility has its own consent form, the method 400 advances to block 418. In block 418, the server 110 obtains the consent form from of the selected medical facility. To do so, the server 110 may communicate with the server 110 to obtain the consent from (e.g., downloading from the selected medical facility or provider's network). In some embodiments, the server 110 may communicate with the selected medical facility to request to send the consent form to the server 110. Alternatively, in other embodiments, the server 110 may retrieve the consent form of the selected medical facility from its database (e.g., 120) if it has been previously received or obtained from the selected medical facility.

In block 420, the server 110 provides the consent form to the applicant for consent for receiving a physical examination at the selected medical facility. To do so, the server 110 may transmit the consent form to the applicant by an email, a text message, or any other method that allows the applicant to view and electronically sign the consent form using a computing device (e.g., 130).

Subsequently, the server 110 receives the electronically signed consent form from the applicant and transmits the electronically signed consent form to the selected medical facility, as indicated in blocks 422 and 424. It should be appreciated that, in some embodiments, the blocks 404-426 of method 400 may be executed concurrently with blocks 334-342 of method 300.

In some embodiments, the selected medical facility may send the consent form directly to the applicant and may receive the electronically signed consent form directly from the applicant. It should be appreciated that the electronically signed consent form may be received from the applicant during the initial online application process or session. Alternatively, an electronic link to the consent form specific to the medical provider or medical facility may be sent to the applicant during the initial online application process for the applicant to complete at the applicant's convenience prior to the physical examination appointment.

In some embodiments, the server 110 may request permission from the applicant to contact the applicant's family members directly to retrieve and/or access their medical and prescription records. For example, with the applicant's permission, the server 110 may transmit electronic requests to the family members to obtain permission, consent, or express authorization for their medical history (e.g., electronic health records, prescription history, medical claim history) via an email and/or a text message.

Exemplary Computer-Implemented Methods

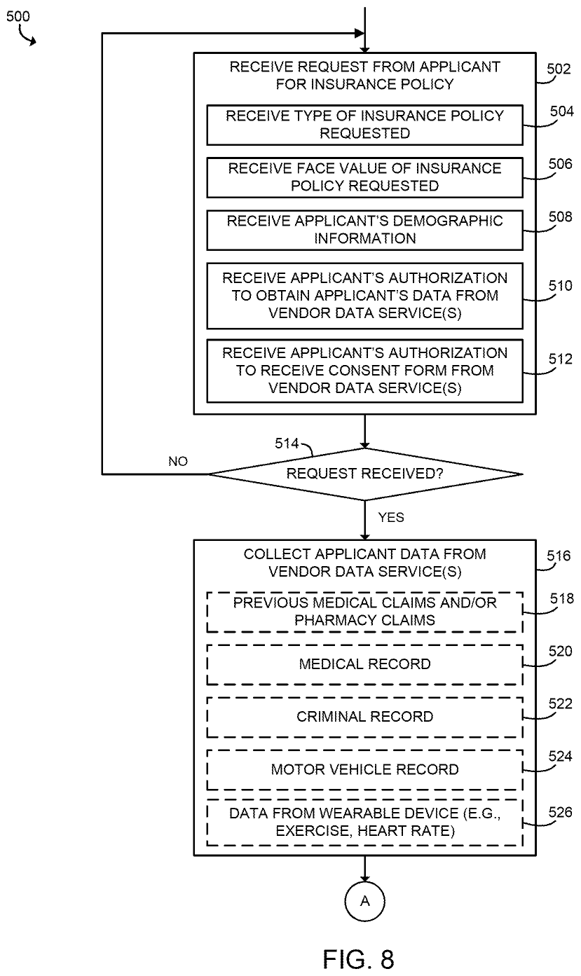

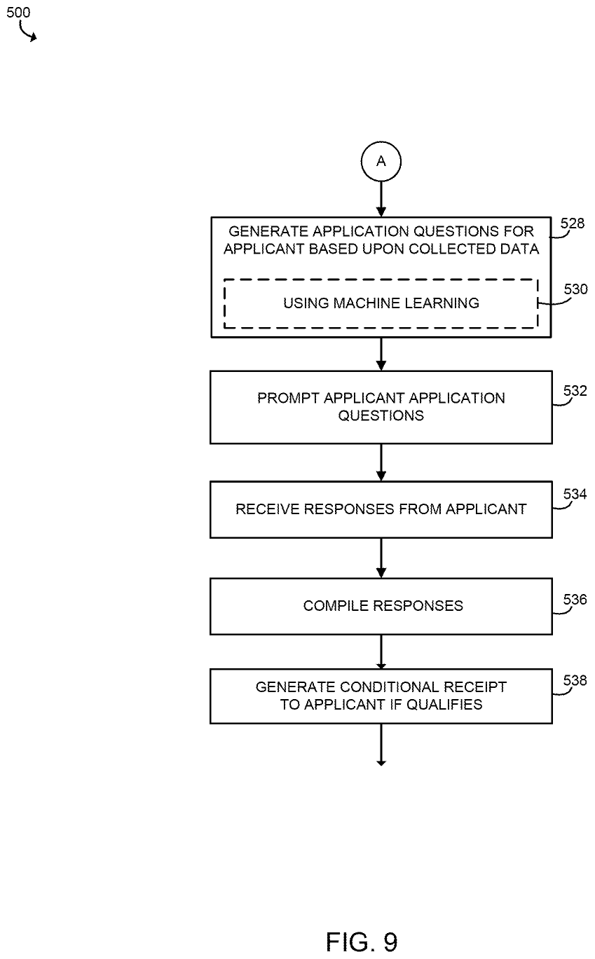

Referring now to FIGS. 8 and 9, another exemplary computer-implemented method 500 for providing application questions tailored to an applicant requesting an insurance policy (e.g., life or health insurance) is shown. In the illustrative embodiment, the method 500 is performed by a server (e.g., 110). To do so, in block 502, the server 110 receives a request from an applicant for an insurance policy from a computing device (e.g., 130). As discussed above, the computing device may be a computer, a notebook, a laptop, a mobile device, a smartphone, a tablet, smart watch, smart glasses, wearable, or any other suitable computing device that is used by the applicant to request the insurance policy.

In the illustrative embodiment, the request includes a type of insurance policy and a face value of insurance policy requested by the applicant, as indicated in blocks 504 and 506, respectively. For example, an applicant may submit a request for a life insurance with $500,000 face value policy. The request further includes the applicant's demographic information, as indicated in block 508. For example, the demographic information may include, but not limited to, age, race, ethnicity, gender, marital status, income, education, and/or employment. In some embodiments, the request may further include family history of the applicant.

Additionally, in the illustrative embodiment, the request further includes a request for an authorization of the applicant to obtain applicant's data from one or more vendor data services (also referred to as one or more third-party servers or third-party service providers in this application), as indicated in block 510. For example, in response to receiving an indication from the applicant requesting for an insurance policy of an insurer, the applicant may be requested to consent and authorize the insurer to obtain relevant data from one or more third-party vendors (e.g., one or more vendor data services) associated with the insurer. Such data may include one or more previous medical claims, one or more pharmacy or prescription claims, one or more medical records, one or more criminal records, one or more motor vehicle records, and data from one or more wearable device(s). It should be appreciated that the type of data collected by the server 110 may depend on the type of insurance policy that is being requested by the applicant. Based in part upon the requested type of insurance policy, the server 110 communicates with one or more corresponding vendor data services to receives, obtains, or otherwise collect the relevant data.

Moreover, in the illustrative embodiment, the request further includes an applicant's authorization to receive one or more consent forms from one or more vendor data services, as indicated in block 512. For example, a physical or medical examination may be required for the applicant for finalizing the eligibility of the requested life or medical insurance policy.

In such example, if a medical facility has any special authorization forms, such as an authorization form specific to that the medical facility, the server 110 may send an email and/or text message to the application with a link so that the applicant can fill out that special authorization form during the online interview. For instance, if the medical facility has its own authorization or other forms that are required to signed by the applicant prior to the medical facility performing any services, the server 110 may send an email and/or text message to the application with a link so that the applicant can fill out any of those forms during the online interview—such as to avoid the filling out those forms at a later date, such as when the applicant arrives at the medical facility for an appointment.

In some embodiments, the server 110 may retrieve or generate the dedicated electronic consent form specific to a medical facility for the physical examination (also commonly referred to as medical examination) or other medical services provider; and/or send or transmit the dedicated electronic authorization or consent form specific to a medical facility for the medical exam or other medical services provider to the applicant's mobile device or other computing device to allow completion by the applicant prior to the medical exam and during the initial online application process or session. Additionally or alternatively, the server 110 may identify or generate an electronic link to the dedicated electronic authorization or consent form specific to a medical facility for the medical exam or other medical services provider; and/or send or transmit the electronic link to the dedicated electronic authorization or consent form specific to a medical facility for the physical examination or other medical services provider to the applicant's mobile device or other computing device to allow completion of the authorization or consent form by the applicant prior to the physical examination and during the initial online application process or session.

If the request is not received in block 514, the method 500 loops back to block 502 to continue waiting for a request from an applicant. If, however, the request is received in block 514, the method 500 advances to block 516.

In block 516, the server 110 receives, obtains, or otherwise collects data related to the applicant from one or more third-party servers (e.g., one or more vendor data services). In some embodiments, the server 110 may receive or obtain previous medical claim(s) and/or previous pharmacy claim(s), as indicated in block 518. Additionally or alternatively, in some embodiments, the server 110 may receive or obtain the medical record(s), the criminal record(s), and/or the motor vehicle record(s) associated with the applicant, as indicated in blocks 520-524, respectively. Additionally or alternatively, in some embodiments, the server 110 may receive or obtain data from one or more wearable devices, as indicated in block 526. For example, the data from a wearable device may include, but not limited to, exercise data, blood pressure, heart rate, pulse, oxygen level, sleep pattern, weight, and temperature.

As described above, the type of data collected by the server 110 may depend on the type of insurance policy that is being requested by the applicant. Based in part upon the requested type of insurance policy, the server 110 communicates with one or more corresponding vendor data services to receives, obtains, or otherwise collect the relevant data.

Once the relevant data is collected, the method 500 advances to block 528 shown in FIG. 9 to generate application questions for the applicant based upon the collected data. It should be appreciated that, in some embodiments, the server 110 may perform machine learning to generate application questions based upon historical data obtained by collecting and analyzing past system performances, as indicated in block 530. As discussed above, by providing the application questions more tailored to the applicant, the server 110 can obtain more relevant data specific to the applicant. Additionally, the personalized application questions may even help the applicant to remember certain relevant information (e.g., by using leading questions) that the applicant may have otherwise forgotten.

Subsequently, in block 532, the server 110 prompts the applicant application questions. Example application questions are illustrated in FIGS. 5 and 6, which is described in detail above. In response to prompting the application questions to the applicant, the server 110 receives responses from the applicant, as indicated in block 534. Based on the received responses, the server 110 compiles the response to generate a conditional receipt, if the applicant qualifies for temporary coverage benefits, as indicated in block 538. The conditional receipt is temporary coverage or a “binding receipt” for an insurance policy. The conditional receipt may provide immediate temporary insurance coverage for the applicant until a policy is subsequently issued or unissued by the insurance provider.

For example, an applicant may be disqualified from a temporary coverage benefit if the compiled response and the collected data indicate that the applicant has been diagnosed with human immunodeficiency virus (HIV) or the Acquired Immune Deficiency Syndrome (AIDS), the applicant is presently incarcerated, and/or the applicant has had a myocardial infarction within three years of the date of application of a life insurance policy.

It should be understood that although the method 500 is described as being performed by the server 110, in some examples, such method may be performed by one or more processors of the server 110.

### ADDITIONAL CONSIDERATIONS

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware is temporarily configured (e.g., programmed), the hardware need not be configured or instantiated at any one instance in time. Software may accordingly configure a processor, for example, to constitute a particular hardware module at one instance of time and to constitute a different hardware module at a different instance of time. Hardware elements can provide information to, and receive information from, other hardware elements. Accordingly, the described hardware may be regarded as being communicatively coupled.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. Similarly, the methods or routines described herein may be at least partially processor-implemented. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. In addition, use of the “a” or “an” are employed to describe elements and components of the embodiments herein. This is done merely for convenience and to give a general sense of the description. In this description, and the claims that follow, the singular also includes the plural unless it is obvious that it is meant otherwise. This detailed description is to be construed as exemplary only and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for system and a method for assigning mobile device data to a vehicle through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

1-16. (canceled)

17. A computer-implemented method for assessing a health status of an individual, comprising:
receiving, by a server via a network, health data from at least one remote server of one or more service providers, the health data including electronic health records, prescription history, medical claim history, and family medical history;
receiving, by the server via the network, sensor data from at least one sensor device associated with the individual, the sensor data including heart activity, sleep history, and exercise information;
analyzing, using at least one machine learning algorithm running on the server, the health data and the sensor data to assess the health status of the individual based upon the health data and the sensor data;
generating, using at least one machine learning algorithm running on the server and based upon the received health data and sensor data, a plurality of questions tailored to the individual regarding the individual's health status;
transmitting from the server via the network for presentation on a computing device associated with the individual at least one question of the plurality of questions;
receiving, by the server via the network, a response from the computing device to the at least one question; and
comparing, by the server, the response to an expected response generated based upon the analysis of the health data and the sensor data to verify accuracy of the response and the health status of the individual.

18. The computer-implemented method of claim 17, further comprising:
receiving, by the server from the computing device, records data including medical records, criminal records, and motor vehicle records;
wherein generating the plurality of questions tailored to the individual includes generating the plurality of questions using the at least one machine learning algorithm running on the server based upon the health data, the sensor data and the records data.

19. The computer-implemented method of claim 17, further comprising:
transmitting, from the server to the computing device, a request for permission from the individual to receive the health data from the at least one remote server of one or more service providers; and
receiving, by the server from the computing device, permission to receive the health data.

20. The computer-implemented method of claim 17, further comprising:
determining whether the individual is taking a prescription drug by analyzing, using the at least one machine learning algorithm running on the server, the health data from the at least one remote server of the one or more service providers.

21. The computer-implemented method of claim 20, further comprising:
transmitting, from the server to the computing device, an inquiry whether the individual is taking the prescription drug; and
responding to a response to the inquiry indicating that the individual is not taking the prescription drug by transmitting a question regarding when the individual stopped taking the prescription drug.

22. The computer-implemented method of claim 17, further comprising:
scheduling, by the server based upon the health status of the individual and a location of the individual, an appointment with a health service provider.

23. The computer-implemented method of claim 22, wherein the scheduling is further based upon a rating of a facility associated with the health service provider.

24. The computer-implemented method of claim 17, further comprising:
accessing, by the server via the network, medical history information of at least one of applicant's family members.

25. A computer system for assessing a health status of an individual, comprising:
a network;
a computing device associated with the individual;
at least one remote server associated with one or more service providers;
at least one sensor device associated with the individual; and
a server communicatively coupled to the computing device, the at least one remote server and the at least one sensor via the network; the server configured to:
receive, via the network, health data from the at least one remote server, the health data including electronic health records, prescription history, medical claim history, and family medical history;
receive, via the network, sensor data from the at least one sensor device, the sensor data including heart activity, sleep history, and exercise information;
analyze, using at least one machine learning algorithm running on the server, the health data and the sensor data to assess the health status of the individual based upon the health data and the sensor data;
generate, using at least one machine learning algorithm running on the server and based upon the received health data and sensor data, a plurality of questions tailored to the individual regarding the individual's health status;
transmit, via the network for presentation on the computing device, at least one question of the plurality of questions;
receive, via the network, a response from the computing device to the at least one question; and
compare the response to an expected response generated based upon the analysis of the health data and the sensor data to verify accuracy of the response and the health status of the individual.

26. The computer system of claim 25, wherein the server is further configured to:
receive, from the computing device, records data including medical records, criminal records, and motor vehicle records; and
generate the plurality of questions tailored to the individual based upon the health data, the sensor data and the records data.

27. The computer system of claim 25, wherein the server is further configured to:
transmit, to the computing device, a request for permission from the individual to receive the health data from the at least one remote server of one or more service providers; and
receive, from the computing device, permission to receive the health data.

28. The computer system of claim 25, wherein the server is further configured to:
determine whether the individual is taking a prescription drug by analyzing, using the at least one machine learning algorithm running on the server, the health data from the at least one remote server of the one or more service providers.

29. The computer system of claim 28, wherein the server is further configured to:
transmit, to the computing device, an inquiry whether the individual is taking the prescription drug; and
respond to a response to the inquiry indicating that the individual is not taking the prescription drug by transmitting a question regarding when the individual stopped taking the prescription drug.

30. The computer system of claim 25, wherein the server is further configured to:
schedule, based upon the health status of the individual and a location of the individual, an appointment with a health service provider.

31. The computer system of claim 30, wherein the appointment is scheduled further based upon a rating of a facility associated with the health service provider.

32. The computer system of claim 25, wherein the server is further configured to:
access, via the network, medical history information of at least one of applicant's family members.

33. A non-transitory computer-readable medium with an executable program stored thereon for assessing a health status of an individual, wherein the program, when executed by a processing element of a server, causes the processing element to perform the following steps:
receive, via a network, health data from at least one remote server, the health data including electronic health records, prescription history, medical claim history, and family medical history;
receive, via the network, sensor data from at least one sensor device, the sensor data including heart activity, sleep history, and exercise information;
analyze, using at least one machine learning algorithm running on the server, the health data and the sensor data to assess the health status of the individual based upon the health data and the sensor data;
generate, using at least one machine learning algorithm running on the server and based upon the received health data and sensor data, a plurality of questions tailored to the individual regarding the individual's health status;
transmit, via the network for presentation on a computing device associated with the individual, at least one question of the plurality of questions;
receive, via the network, a response from the computing device to the at least one question; and
compare the response to an expected response generated based upon the analysis of the health data and the sensor data to verify accuracy of the response and the health status of the individual.

34. The non-transitory computer-readable medium of claim 33, wherein the program further causes the processing element to:
receive, from the computing device, records data including medical records, criminal records, and motor vehicle records; and
generate the plurality of questions tailored to the individual based upon the health data, the sensor data and the records data.

35. The non-transitory computer-readable medium of claim 33, wherein the program further causes the processing element to:
determine whether the individual is taking a prescription drug by analyzing, using the at least one machine learning algorithm running on the server, the health data from the at least one remote server of the one or more service providers.

36. The non-transitory computer-readable medium of claim 33, wherein the program further causes the processing element to:
schedule, based upon the health status of the individual and a location of the individual, an appointment with a health service provider.
